(19) United States
(12) Patent Application Publication
(10) Pub. No.: US 2010/0090960 A1
(43) Pub. Date: Apr. 15, 2010

(54) Methods, Systems and Computer Program Products for Shared Input Key Functions Between Mobile Devices

(75) Inventors: Gregory A. Dunko, Cary, NC (US); Yojak Vasa, Cary, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 12/251,758

(22) Filed: Oct. 15, 2008

(51) Int. Cl. G06F 3/02

(52) U.S. Cl. 345/169

(57) ABSTRACT

Methods, systems, mobile devices and computer program products for sharing input keys between mobile devices are provided. A communication link is established between at least two mobile devices. Each of the at least two mobile devices includes available input keys that are mapped to corresponding input functions in a first configuration. An application is selected for operation on at least one of the mobile devices. The application includes a plurality of input functions. A set of input keys is identified from the available keys on the at least two mobile devices based on the plurality of input functions of the application. The set of input keys are remapped on the at least two mobile devices in a second configuration in which the plurality of input functions of the application are mapped to the set of input keys. User input is accepted from the set of input keys on the at least two mobile devices to thereby operate the selected application.

### FIELD OF THE INVENTION

The present invention relates to keyboards for a mobile terminal.

### BACKGROUND

As consumer preferences and improved technology results in smaller electronic devices, the space available on electronic devices for displays and keypads and other user interfaces is increasingly limited. Keypads and touch sensitive screens have been engineered for space efficiency in these environments. However, the functionality and/or ease of use may be compromised in an effort to decrease the size of the user interface. For example, multifunctional keys can be confusing to the user and may still not provide the number of input keys needed for desired operations.

An increasing number of users may also use mobile devices for text messaging or electronic mail functions. Typical mobile telephone include a standard, numeric keyboard with twelve keys, i.e., for numbers 0-9, a “*” key and a “#” key. The numeric keyboard may be used as a text keyboard by pressing a single key multiple times to select a letter. However, this operation is generally cumbersome and time consuming for a user.

### SUMMARY OF EMBODIMENTS OF THE INVENTION

In some embodiments, methods for sharing input keys between mobile devices are provided. A communication link is established between at least two mobile devices. Each of the at least two mobile devices includes available input keys that are mapped to corresponding input functions in a first configuration. An application is selected for operation on at least one of the mobile devices. The application includes a plurality of input functions. A set of input keys is identified from the available keys on the at least two mobile devices based on the plurality of input functions of the application. The set of input keys are remapped on the at least two mobile devices in a second configuration in which the plurality of input functions of the application are mapped to the set of input keys. User input is accepted from the set of input keys on the at least two mobile devices to thereby operate the selected application.

In some embodiments, the input keys include respective display regions and each of the display regions are configured to display a plurality of input identification icons. The first key configuration includes a first set of the plurality of input identification icons and the second key configuration comprises a second set of the plurality of input identification icons that corresponds to the plurality of input functions of the application. The second set of the plurality of input identification icons is displayed after remapping the set of input keys.

In some embodiments, the two mobile devices are mobile communications terminals. Each of the at least two mobile devices can include a respective keyboard having at least thirteen available input keys, and the first configuration of the at least two mobile devices is a numeric keyboard. The second configuration of the at least two mobile devices can include a QWERTY keyboard including the at least thirteen available input keys of the at least two mobile devices.

In some embodiments, the at least two mobile devices each include a display. An operation of the displays of the at least two mobile devices are controlled with the application on one of the at least two mobile devices.

In some embodiments, the at least two mobile devices each include a speaker. An operation of the speakers of the at least two mobile devices is controlled with the application on one of the at least two mobile devices.

In some embodiments, the at least two mobile devices are rigidly coupled by a connector.

According to some embodiments of the present invention, systems for sharing input keys between mobile devices including available input keys that are mapped to corresponding input functions in a first configuration are provided. The system includes a controller configured to establish a communication link between at least two mobile devices, to select an application comprising a plurality of input functions for operation on at least one of the mobile devices, to identify a set of input keys from the available keys on the at least two mobile devices based on the plurality of input functions of the application, to remap the set of input keys on the at least two mobile devices in a second configuration in which the plurality of input functions of the application are mapped to the set of input keys, and to accept user input from the set of input keys on the at least two mobile devices to thereby operate the selected application.

In some embodiments, the input keys of the at least two mobile devices include respective display regions, and each of the display regions are configured to display a plurality of input identification icons. The first key configuration includes a first set of the plurality of input identification icons, and the second key configuration includes a second set of the plurality of input identification icons that corresponds to the plurality of input functions of the application. The controller is further configured to control displaying the second set of the plurality of input identification icons after remapping the set of input keys.

In some embodiments, the two mobile devices are mobile communications terminals. Each of the at least two mobile devices can include a respective keyboard having at least thirteen available input keys and the first configuration of the at least two mobile devices is a numeric keyboard. The second configuration of the at least two mobile devices can include a QWERTY keyboard comprising the at least thirteen available input keys of the at least two mobile devices.

In some embodiments, the at least two mobile devices each include a display and the controller is configured to control an operation of the displays of the at least two mobile devices with the application on one of the at least two mobile devices.

In some embodiments, the at least two mobile devices each include a speaker and the controller is configured to control an operation of the speakers of the at least two mobile devices with the application on one of the at least two mobile devices.

In some embodiments, a mobile device for sharing input keys with another mobile device including a plurality of input keys that are mapped to corresponding input functions is provided. The mobile device includes a hand-held unit having a plurality of input keys that are mapped to corresponding input functions in a first configuration. A controller is configured to establish a communication link with another mobile device, to select an application comprising a plurality of input functions for operation on at least one of the mobile devices, to identify a set of input keys from the available keys on the mobile devices based on the plurality of input functions of the application, to remap the set of input keys on the mobile devices in a second configuration in which the plurality of input functions of the application are mapped to the set of input keys, to display the plurality of input function on the set of input keys and to accept user input from the set of input keys on the mobile devices to thereby operate the selected application.

In some embodiments, a computer program product for sharing input keys between at least two mobile devices is provided. Each of the at least two mobile devices includes available input keys that are mapped to corresponding input functions in a first configuration. The computer program product includes a computer readable storage medium having computer readable program code embodied in the medium. The computer readable program code includes computer readable program code configured to establish a communication link between at least two mobile devices, to select an application comprising a plurality of input functions for operation on at least one of the mobile devices, to identify a set of input keys from the available keys on the mobile devices based on the plurality of input functions of the application, to remap the set of input keys on the mobile devices in a second configuration in which the plurality of input functions of the application are mapped to the set of input keys, and to accept user input from the set of input keys on the mobile devices to thereby operate the selected application.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a front view of two mobile communications devices according to some embodiments of the present invention.

FIG. 2 is a front view of the two mobile communications devices of FIG. 1 in a reoriented, joint communications position.

FIG. 3 is a front view of the two mobile communications device of FIG. 2 in which the input keys of the devices are remapped to accept user input from both keys to permit expanded operations to operate an application according to some embodiments of the present invention.

FIG. 4 is a flowchart illustrating operations according to some embodiments of the present invention.

FIG. 5 is a schematic block diagram illustrating a wireless communication system with a wireless mobile communications device according to some embodiments of the invention.

### DETAILED DESCRIPTION OF EMBODIMENTS OF THE INVENTION

The present invention now will be described hereinafter with reference to the accompanying drawings and examples, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under.”The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise. The present invention is described below with reference to block diagrams and/or flowchart illustrations of methods, apparatus (systems) and/or computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, embodiments of the present invention may take the form of a computer program product on a computer-usable or computer-readable storage medium having computer-usable or computer-readable program code embodied in the medium for use by or in connection with an instruction execution system.

The computer-usable or computer-readable medium may be, for example but not limited to, an electrical connection having one or more wires, a portable computer diskette, a random access memory (RAM), a read-only memory (ROM), an erasable programmable read-only memory (EPROM or Flash memory), and a portable compact disc read-only memory (CD-ROM).

As used herein, a “mobile terminal” includes, but is not limited to, a terminal that is configured to receive communication signals via a wireless interface from, for example, a cellular network, a Wide Area Network, wireless local area network (WLAN), a GPS system, and/or another RF communication device. Example mobile terminals include, but are not limited to, a cellular mobile terminal; a GPS positioning receiver; an acceleration measurement device with a wireless receiver; a personal communication terminal that may combine a cellular mobile terminal with data processing, facsimile and data communications capabilities; a personal data assistance (PDA) that can include a wireless receiver, pager, Internet/intranet access, local area network interface, wide area network interface, Web browser, organizer, and/or calendar; and a mobile or fixed computer or other device that includes a wireless receiver.

As used herein, a “display” includes, but is not limited to, a device capable of providing a visual representation, such as graphics, lighting or back-lighting for displaying information and/or for aesthetic purposes.

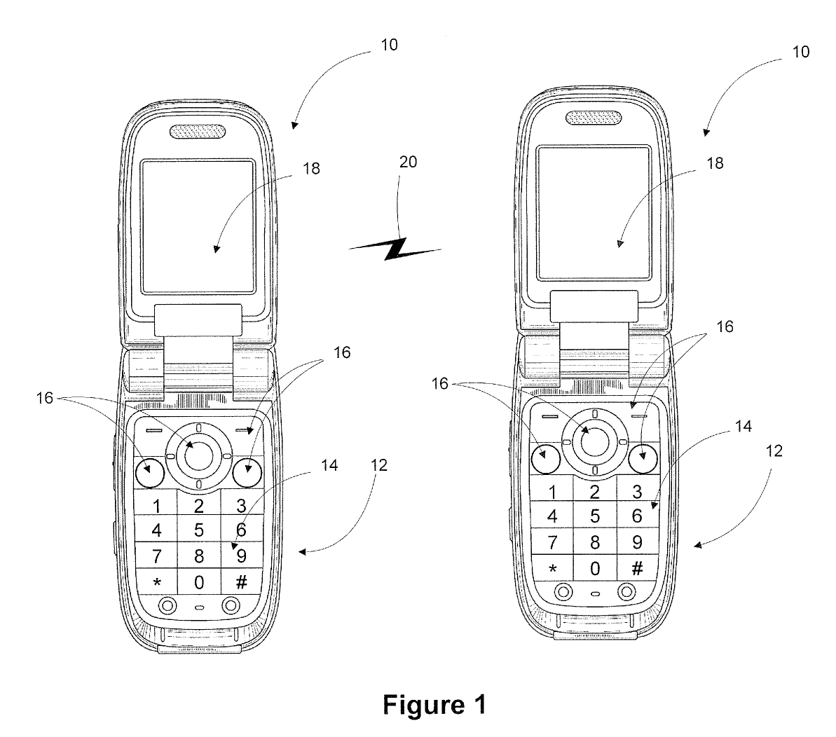

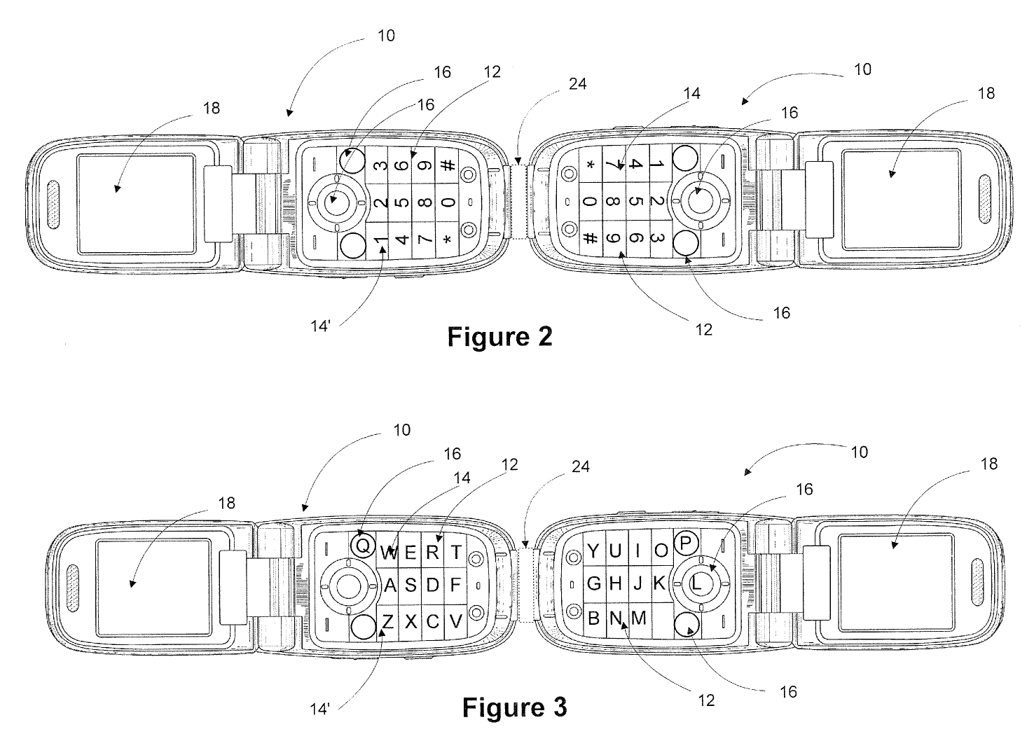

As illustrated in FIGS. 1-2, two mobile communications devices 10 each include a keyboard 12 that includes numerical or primary input keys 14 and auxiliary input keys 16. The devices 10 also include a display 18. A communication link 20 can be formed between the devices 10. The communication link 20 can be a Bluetooth interface, a wireless local area network interface (e.g., 802.11), another RF communication interface, and/or an optical/infra-red communication interface. According to some embodiments and as illustrated in FIGS. 1-3, the mobile devices 10 are handheld (portable) mobile terminals. By “handheld” mobile terminal, it is meant that the outer dimensions of the mobile terminal are adapted and suitable for use by a typical operator using one hand. According to some embodiments, the total volume of the handheld mobile terminal is less than about 200 cc. According to some embodiments, the total volume of the handheld terminal is less than about 100 cc. According to some embodiments, the total volume of the handheld mobile terminal is between about 50 and 100 cc. According to some embodiments, no dimension of the handheld mobile terminal 10 exceeds about 200 mm.

The input keys 14, 16 are initially mapped to corresponding input functions in a configuration as illustrated in FIGS. 1-2. The input keys 14 form a standard numerical keyboard of twelve input keys for numbers (0-9) and for a “*” key and a “#” key. The auxiliary input keys 16 provide additional functions, such as to initiate a menu, select a particular menu item or provide arrow functions. In some embodiments, the keys 14, 16 can include “hard keys,” in which the function of the keys generally does not change or “soft keys.” in which the function of the keys typically changes, e.g., based on the mode of device operation. The function of soft keys can be indicated on the display 18. As can be seen in FIGS. 1-2, neither of the mobile communications devices 10 alone include enough keys to provide a full alphabet for use as a texting keyboard, such as a standard QWERTY keyboard. As shown in FIG. 2, the devices 10 can be reoriented for joint keyboard operations as described herein, and an optional connector 24 can be used to rigidly connect the devices 10. The connector 24 can be integral to one of the devices 10 or provided as a separate connecting unit. In some embodiments, the connector 24 can include a communications link, such as a wired or infrared connection, between the devices 10. In some embodiments, the connector 24 may be omitted, and the keys 14, 16 can be used jointly without a physical connection between the devices.

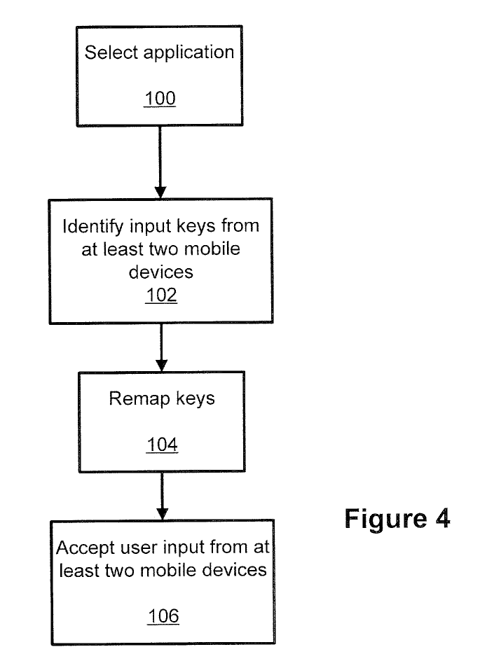

According to some embodiments of the present invention and with reference to FIG. 4, an application is selected for operation on at least one of the mobile devices 10 (Block 100). The application includes a set of input functions. For example, if the application is an application that uses text inputs, the set of input functions can include the alphabet and/or numeric key inputs. A set of input keys is identified from the available keys 14, 16 of the two mobile devices based on the desired input keys of the application (Block 102). The set of input key from the available keys 14, 16 are remapped on the at least two mobile devices in a second configuration such that the plurality of input functions of the application are mapped to the set of input keys (Block 104). User input can then be accepted from the remapped set of input keys on the two mobile devices 10 to thereby operate the selected application (Block 106).

For example, the keys 14, 16 of the keyboard 12 can be reoriented as shown in FIGS. 2-3, and the keys 14, 16 can be remapped to provide a full text keyboard, such as a QWERTY keyboard as shown in FIG. 3. Therefore, two mobile devices 10 can provide an expanded keyboard using input keys 14, 16 from both of the devices 10 to operate a single application. In some embodiments, one of the mobile devices 10 has unidirectional control over other device 10 to run the application, i.e., in a “master-slave” model of communication.

As illustrated in FIGS. 2-3, each of the input keys 14, 16 can include a display region on a surface thereof that is configured to selectively display one of a plurality of identification icons. In some embodiments, the display regions of the keys 14, 16 are configured to display the appropriate key input identifier based on the remapped configuration of the keys 14, 16. For example, the key 14′ can be configured to display either a “1” or a “Z” as shown in FIGS. 2-3. The display regions of the keys 14, 16 can include light guides and/or image projectors to selectively display an image of the desired key input identifier. Exemplary display configurations for displaying a plurality of different key identification icons are disclosed in U.S. Patent Publication No. 2007/0236959 to Tolbert, the disclosure of which is hereby incorporated by reference in its entirety.

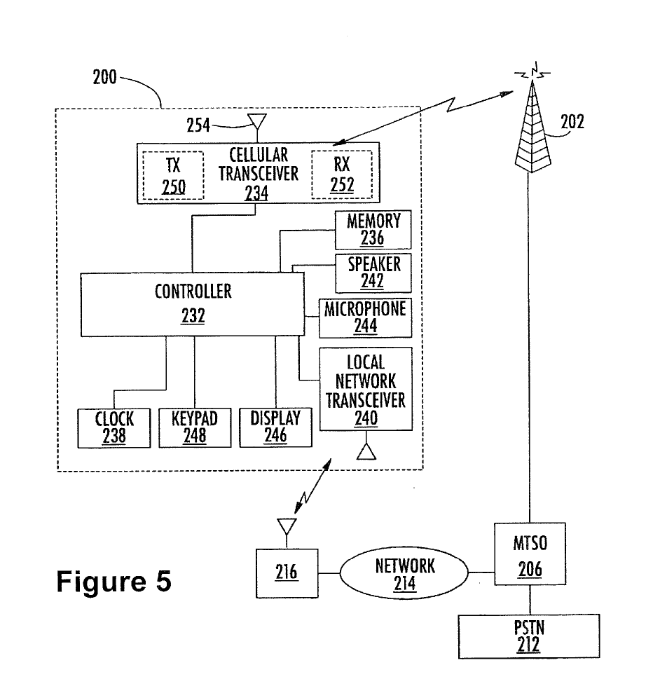

FIG. 5 is a schematic block diagram of a wireless communication system that includes a wireless terminal 200, such as a mobile wireless communications terminal, that receives wireless communication signals from a cellular base station 202 and/or a wireless local network 216. The cellular base station 202 is connected to a Mobile Telephone Switching Office (MTSO) 206, which, in turn, is connected to a Public Switched Telephone Network (PSTN) 212, and a network 214 (e.g., Internet). The mobile terminal 200 may communicate with the wireless local network 216 using a communication protocol that may include, but is not limited to, 802.11a, 802.11b, 802.11e, 802.11g, 802.11i, and/or other wireless local area network protocols. The wireless local network 216 may be connected to the network 214.

In some embodiments of the invention, the mobile terminal 200 includes a controller 232, a cellular transceiver 234, a memory 236, a timing circuit (clock) 238, a local network transceiver 240, a speaker 242, a microphone 244, a display 246 and a keypad 248.

The memory 236 stores software that is executed by the controller 232, and may include one or more erasable programmable read-only memories (EPROM or Flash EPROM), battery backed random access memory (RAM), magnetic, optical, or other digital storage device, and may be separate from, or at least partially within, the controller 232. The controller 232 may include more than one processor, such as, for example, a general purpose processor and a digital signal processor, which may be enclosed in a common package or separate and apart from one another.

In particular, the controller 232 may be configured to control operations as described with respect to FIGS. 1-4, for example, by determining a set of input keys and remapping available input keys on the devices to provide joint inputs from two mobile devices (e.g., the devices 10 in FIGS. 1-3). In some embodiments, the controller 232 may display various images on a set of keys corresponding to a remapped configuration of the input keys or a mode of operation for a device. For example, the controller 232 may request a corresponding controller in another device to remap the key labeling as described with respect to FIGS. 1-4.

The cellular transceiver 234 typically includes both a transmitter (TX) 250 and a receiver (RX) 252 to allow two way communications, but the present invention is not limited to such devices and, as used herein, a “transceiver” may include only the receiver 252. The mobile terminal 200 may thereby communicate with the base station 202 using radio frequency signals, which may be communicated through an antenna 254. For example, the mobile terminal 200 may be configured to communicate via the cellular transceiver 234 using one or more cellular communication protocols such as, for example, Global Standard for Mobile (GSM) communication, General Packet Radio Service (GPRS), enhanced data rates for GSM evolution (EDGE), Integrated Digital Enhancement Network (iDEN), code division multiple access (CDMA), wideband-CDMA, CDMA2000, Universal Mobile Telecommunications System (UMTS), WiMAX, HIPERMAN, wireless local area network (e.g., 802.11), and/or Bluetooth. The transceiver 234 can also be used to form the communication link 20 between the devices 10. Communication protocols as used herein may specify the information communicated, the timing, the frequency, the modulation, and/or the operations for setting-up and/or maintaining a communication connection.

Although embodiments according to the present invention are described herein with respect to a remapped, QWERTY keyboard configuration, it should be understood that any suitable keyboard configuration can be used, including keyboard configurations suitable for gaming, texting, camera, video or other device functions.

Moreover, although described herein with respect to shared keyboard functions, it should be understood that the controller 232 can be configured to control various elements of both of the devices 10. In some embodiments, the controller 232 can control a speaker 242 and/or a display 246 on both of the devices 10 to provide jointly controlled operations, such as stereo sound using speakers 242 from both devices 10 or jointly displayed graphics on the display 246 of both of the devices 10.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method for sharing input keys between mobile devices, the method comprising:
establishing a communication link between at least two mobile devices, each of the at least two mobile devices including available input keys that are mapped to corresponding input functions in a first configuration;
selecting an application for operation on at least one of the mobile devices, the application comprising a plurality of input functions;
identifying a set of input keys from the available keys on the at least two mobile devices based on the plurality of input functions of the application;
remapping the set of input keys on the at least two mobile devices in a second configuration in which the plurality of input functions of the application are mapped to the set of input keys; and
accepting user input from the set of input keys on the at least two mobile devices to thereby operate the selected application.

2. The method of claim 1, wherein the input keys comprise respective display regions and each of the display regions are configured to display a plurality of input identification icons, wherein the first key configuration comprises a first set of the plurality of input identification icons and the second key configuration comprises a second set of the plurality of input identification icons that corresponds to the plurality of input functions of the application, the method further comprising displaying the second set of the plurality of input identification icons after remapping the set of input keys.

3. The method of claim 1, wherein the two mobile devices comprise mobile communications terminals.

4. The method of claim 3, wherein each of the at least two mobile devices comprises a respective keyboard having at least thirteen available input keys and the first configuration of the at least two mobile devices is a numeric keyboard.

5. The method of claim 4, wherein the second configuration of the at least two mobile devices comprises a QWERTY keyboard comprising the at least thirteen available input keys of the at least two mobile devices.

6. The method of claim 1, wherein the at least two mobile devices each comprise a display, the method comprising controlling an operation of the displays of the at least two mobile devices with the application on one of the at least two mobile devices.

7. The method of claim 1, wherein the at least two mobile devices each comprise a speaker, the method comprising controlling an operation of the speakers of the at least two mobile devices with the application on one of the at least two mobile devices.

8. The method of claim 1, further comprising rigidly coupling the at least two mobile devices with a connector.

9. A system for sharing input keys between mobile devices including available input keys that are mapped to corresponding input functions in a first configuration, the system comprising:
a controller configured to establish a communication link between at least two mobile devices, to select an application comprising a plurality of input functions for operation on at least one of the mobile devices, to identify a set of input keys from the available keys on the at least two mobile devices based on the plurality of input functions of the application, to remap the set of input keys on the at least two mobile devices in a second configuration in which the plurality of input functions of the application are mapped to the set of input keys, and to accept user input from the set of input keys on the at least two mobile devices to thereby operate the selected application.

10. The system of claim 9, wherein the input keys of the at least two mobile devices comprise respective display regions and each of the display regions are configured to display a plurality of input identification icons, wherein the first key configuration comprises a first set of the plurality of input identification icons and the second key configuration comprises a second set of the plurality of input identification icons that corresponds to the plurality of input functions of the application, wherein the controller is further configured to control displaying the second set of the plurality of input identification icons after remapping the set of input keys.

11. The system of claim 10, wherein the two mobile devices comprise mobile communications terminals.

12. The system of claim 11, wherein each of the at least two mobile devices comprises a respective keyboard having at least thirteen available input keys and the first configuration of the at least two mobile devices is a numeric keyboard.

13. The system of claim 12, wherein the second configuration of the at least two mobile devices comprises a QWERTY keyboard comprising the at least thirteen available input keys of the at least two mobile devices.

14. The system of claim 9, wherein the at least two mobile devices each comprise a display and the controller is configured to control an operation of the displays of the at least two mobile devices with the application on one of the at least two mobile devices.

15. The system of claim 9, wherein the at least two mobile devices each comprise a speaker and the controller is configured to control an operation of the speakers of the at least two mobile devices with the application on one of the at least two mobile devices.

16. A mobile device for sharing input keys with another mobile device comprising a plurality of input keys that are mapped to corresponding input functions, the mobile device comprising:
a hand-held unit comprising a plurality of input keys that are mapped to corresponding input functions in a first configuration;
a controller configured to establish a communication link with another mobile device, to select an application comprising a plurality of input functions for operation on at least one of the mobile devices, to identify a set of input keys from the available keys on the mobile devices based on the plurality of input functions of the application, to remap the set of input keys on the mobile devices in a second configuration in which the plurality of input functions of the application are mapped to the set of input keys, to display the plurality of input function on the set of input keys and to accept user input from the set of input keys on the mobile devices to thereby operate the selected application.

17. A computer program product for sharing input keys between at least two mobile devices, each of the at least two mobile devices including available input keys that are mapped to corresponding input functions in a first configuration, the computer program product comprising:
computer readable storage medium having computer readable program code embodied in said medium, the computer readable program code comprising:
computer readable program code configured to establish a communication link between at least two mobile devices;
computer readable program code configured to select an application for operation on at least one of the mobile devices, the application comprising a plurality of input functions;
computer readable program code configured to identify a set of input keys from the available keys on the at least two mobile devices based on the plurality of input functions of the application;
computer readable program code configured to remap the set of input keys on the at least two mobile devices in a second configuration in which the plurality of input functions of the application are mapped to the set of input keys; and
computer readable program code configured to accept user input from the set of input keys on the at least two mobile devices to thereby operate the selected application.
